(19) United States
(12) Patent Application Publication
(10) Pub. No.: US 2009/0277474 A1
(43) Pub. Date: Nov. 12, 2009

(54) Bore Brush

(76) Inventors: Doug Minnear, Mansfield, OH (US); Scott Boyd Huffman, Deleware, OH (US); Mark Huffman, Deleware, OH (US)

Correspondence Address: GREENBERG & LIEBERMAN, LLC, 2141 WISCONSIN AVE, N.W., SUITE C-2, WASHINGTON, DC, 20007, US

(21) Appl. No.: 11/458,014

(22) Filed: Jul. 17, 2006

Related U.S. Application Data
(60) Provisional application No. 60/595,571, filed on Jul. 16, 2005.

(51) Int. Cl. B08B 9/04

(52) U.S. Cl. 134/8; 15/88

(57) ABSTRACT

A bore cleaner for a tank that literally crawls through the bore of the tank, and in the process of crawling through the bore, cleans the interior walls of the bore with very little user intervention or monitoring. The bore cleaner extends and retracts as it moves through the bore of the tank, and as it extends and retracts, brushes on the present invention rub against the inside of the bore of the tank and remove debris. When the bore cleaner reaches one end of the bore of the tank, slight user intervention is necessary to reverse the direction of the brushes on the bore cleaner.

### FIELD OF THE INVENTION

The present invention relates to bore brushes and more specifically, the present invention relates to bore brushes that are typically used in a gun barrel, such as the gun barrel of a tank.

### BACKGROUND OF THE INVENTION

When a tank or Howitzer fires in the field of battle, it propels an object through a bore and after repeated firings, the bore becomes dirty and needs to be cleaned. Currently, as our troops fight in the war in Iraq, a good part of the troops' time is occupied with cleaning the bores of tanks or Howitzers. Typically, four to six soldiers will work together to clean a gun tube. They will insert brushes on a ram staff attachment and literally, the four to six troops push the brushes through the gun tube to clean debris. Once the brushes reach one end of the bore, the troops then need to pull the brushes back through the bore, so that the tank can fire again without the brushes obstructing the firing. The cleaning process that the four to six troops use takes anywhere from one to four hours. In the field of battle, up to four hours is a lot of time that could be better spent on sleep or other activities, rather than simply cleaning the bore of a tank or Howitzer.

U.S. Pat. No. 3,004,278 issued to Stanley on Oct. 17, 1961, is a pipe cleaning device that uses complex gear assemblies to clean the interiors of large pipes. The device is configured to automatically reverse when a switch is triggered after it reaches the end of a pipe. Unlike the present invention, this invention is incapable of cleaning a small tube such as a tank barrel. In addition, its complex system of gears makes this invention heavy, bulky, and prone to mechanical failure. Thus, this invention is not suited to military fieldwork.

U.S. Pat. No. 3,078,823 issued to Cummings on Feb. 25, 1963, is a pipe cleaning device that cleans the interiors of pipes. Unlike the present invention, it is propelled through the pipe by a set of wheels and has a movable brush head affixed to its front. Also unlike the present invention, it is incapable of cleaning small diameter pipes such as a tank barrel and is bulky, such that field use would be difficult.

U.S. Pat. No. 4,037,349 issued to Calvin on Jun. 27, 1977, is a pipe cleaner that is wheel driven, features a rotating brush head affixed to its front, and is pneumatically powered. Unlike the present invention, it is bulky and cannot clean smaller pipes, such as a gun barrel. Also, its pneumatic power source makes it less fit for operation in the field.

U.S. Pat. No. 4,290,163 issued to Opitz on Sep. 22, 1981 is a gun cleaning device that propels itself through a gun bore on wheels, has a switching arrangement for when the end of the barrel is reached, and has axially rotating brushes affixed upon its ends. It also includes an oiling provision for the gun. Unlike the present invention, it relies upon wheels, instead of a much simpler push/pull motion for propulsion. This makes it bulkier and less suitable for use in the field. Also, unlike the present invention, the switching arrangement relies upon sensing a physical barrier at the end of the barrel as opposed to sensing a no load condition.

U.S. Pat. No. 4,369,071 issued to Flach, et. all on Jan. 18, 1983 is a cleaning device for a gun barrel that is propelled by wheels and features rotating brushes affixed to its front. The device also includes a system for introducing it into the barrel. Unlike the present invention, it uses wheels for propulsion and is larger and bulkier then the present invention, making it unfit for field use.

Japanese Publication 11015531 A, published for Hideaki et. all on Jan. 22, 1999, is a system that stops a device once it reaches a stop point by recognizing that a change in the voltage of the drive motor has occurred. Unlike the present invention, it is incapable of cleaning anything. Also, unlike the present invention which senses a no load condition, Hideaki's invention simply recognizes a change in voltage.

Thus, there is a need for a quick and easy way to clean the bore of a tank or Howitzer that involves very little manpower. Furthermore, there is a need for a device that is capable of cleaning the bore of a tank or Howitzer that is small and portable enough to be transported with troops into the field of battle, or to any position at which the troops might be located.

Additionally, it is desirable to have a device that is capable of cleaning the bore of a tank or Howitzer that is capable of operating via the conventional power that the tank, or other military vehicles, could supply to the device, as opposed to having to plug the device into a generator or other power grid. Moreover, there is a need for a device for cleaning the bore of a tank or Howitzer that has safety precautions built into it, so that it operates independently without much user supervision.

### SUMMARY OF THE INVENTION

The present invention is a bore cleaner for a tank that literally crawls through the bore of the tank, and in the process of crawling through the bore, cleans the interior walls of the bore with very little user intervention or monitoring. The present invention extends and retracts as it moves through the bore of the tank, and as it extends and retracts, brushes on the present invention rub against the inside of the bore of the tank and remove debris. When the present invention reaches one end of the bore of the tank, slight user intervention is necessary to reverse the direction of the brushes on the present invention. Once the brush direction has been reversed, the present invention is restarted, and on its own, the present invention extends and retracts back through the bore of the tank until it reaches the point of the bore where it originally entered. Then the user simply removes the present invention from the bore of the tank, and the tank can fire because it now has a clean bore. A demonstration video is available at www.graywacke.net when the “Pneumatic Bore Brush” or “Electronic Bore Cleaning” hyperlink is selected.

### BRIEF DESCRIPTION OF DRAWINGS

FIG. 1 is a cross-section of the present invention without brushes, showing the present invention in a retracted position.

FIG. 2 is a cross-section of the present invention with brushes, showing the present invention in a retracted position.

FIG. 3 is a cross-section of the present invention with brushes, showing the present invention in an extended position.

FIG. 4 is a cross-section of the present invention without brushes, showing the present invention in retracted form with an alternate power cord routing.

### DETAILED DESCRIPTION OF THE PRESENT EMBODIMENT

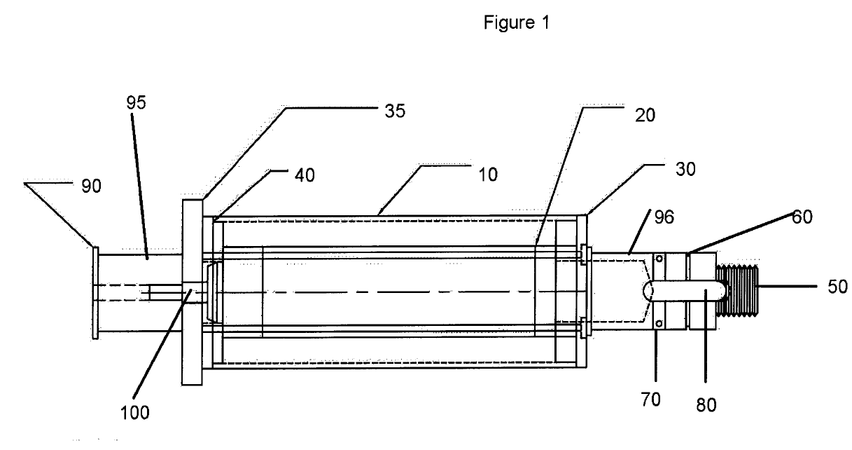

As shown in FIG. 1, the present invention has a tube (10) that is disposed between a rear brush lug plate (30) and a front mount plate (40). Inside tube (10) is housed a mechanical actuator motor (20). Brush mount (95) serves as a point on which a conventional brush can be mounted, and end plate (35) helps to maintain the integrity of tube (10), front brush lug (90) helps to ensure that a conventional brush stays on brush mount (95).

Threads (50) receive a conventional handle that is screwed onto threads (50), so that the present invention can be manipulated by a user. Cord guide (80) is merely a path or chamber allowing cords that power mechanical actuator motor (20) to enter and exit the present invention. In an alternative embodiment of the invention, a cord guide is not used and the cord is routed through the center of the rear of the bore cleaner. Groove (60) is disposed between threads (50) and rear brush lug plate (30) to receive a conventional retainer clip to ensure that a conventional brush mounted on the present invention will not slide off the rear end of the present invention. Rear brush mount (96) is the point at which a conventional brush would be mounted on the present invention. Thus, a brush mounted on the rear of the present invention would be held between groove (60) and rear brush lug plate (30). Shaft (100) emanates from mechanical actuator motor (20) and as shaft (100) extends from mechanical actuator motor (20), it moves brush mount (95) farther from tube (10).

As shown in FIG. 2, rear brush (110) and front brush (120) are disposed on rear brush mount (96) and brush mount (95) respectively. In the preferred embodiment of the design, the brush will be attached to brush mount (95) by a knurled thumb screw that bolts into a threaded receptacle in member (90). Such installation can be performed by hand without the need for tools. In an one alternative embodiment of the design, the brush will be secured by a retaining washer that fits into a groove on member (90). There is no difference between the present invention as shown in FIG. 2 and the present invention as shown in FIG. 1, but for the addition of rear brush (110) and front brush (120) in FIG. 2. FIG. 2 is offered to appreciate how the present invention will appear when rear brush (110) and front brush (120) are attached to it. Rear brush (110) and front brush (120) are merely conventional brushes, with bristles that will clean the inside of the bore of a tank when the present invention is inserted therein.

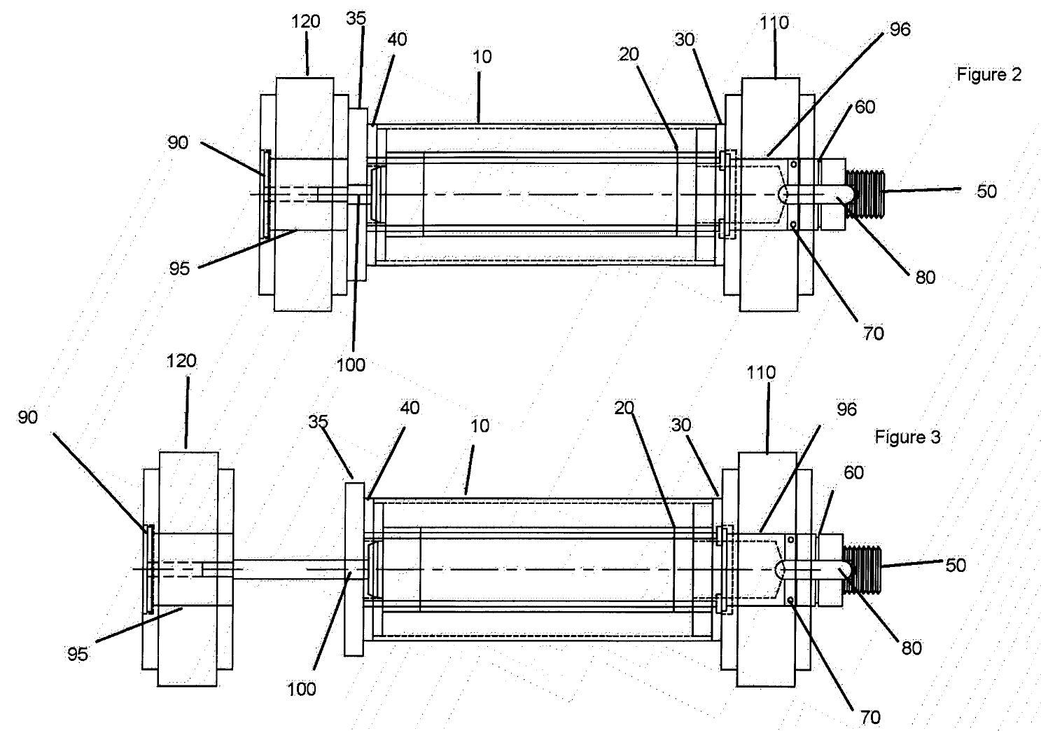

FIG. 3 shows the present invention with shaft (100) extended from mechanical actuator motor (20). Thus, in FIG. 3, brush mount (95), as well as front brush (120), have been extended away from tube (10). Aside from the extension of shaft (100), present invention, as shown in FIG. 3, is the same as the present invention as shown in FIG. 2.

A method by which the present invention operates will now be explained with reference to FIGS. 1, 2, 3, and 4. The present invention, as shown in FIG. 1, is fully functional, but for missing rear brush (110) and front brush (120). A user would place rear brush (110) and front brush (120) onto the present invention, so that the present invention would appear as shown in FIG. 2. Conventional tightening mechanisms, screws, threads, et cetera, allow rear brush (110) and front brush (120) to be mounted to the present invention.

Next, the user would screw a conventional handle onto threads (50). A conventional handle is typically 2½ to 3 feet long and comes in sections, so that once the first section of the conventional handle is screwed onto threads (50), the remaining sections of the handle would be screwed to one another, so that the conventional handle would be of sufficient length.

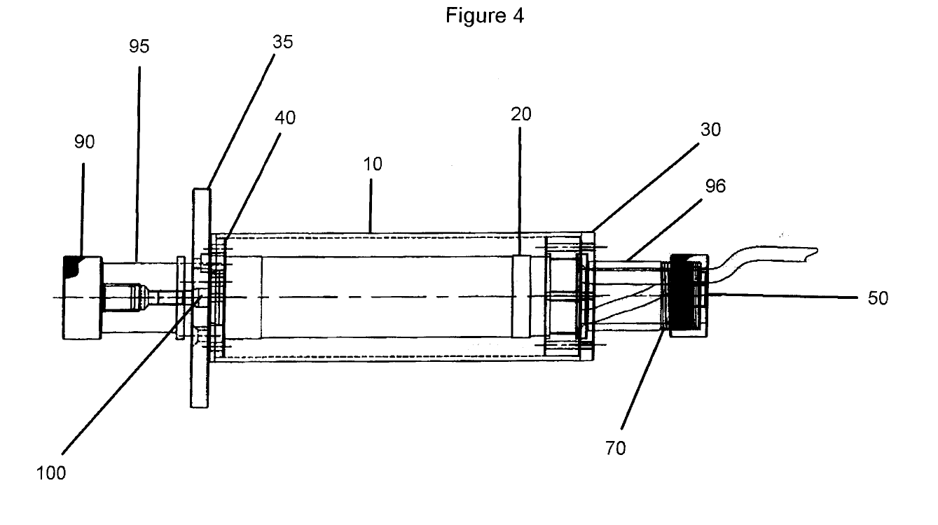

The user would next take conventional wires emanating from mechanical actuator motor (20) through cord guide (80), and plug them into a conventional tank, or a conventional support vehicle's NATO connector. FIG. 4 shows an alternative embodiment of the present invention in which a cord guide is no longer used and the power cables are routed out through the center of the rear of the bore cleaner. The user would then attach a conventional lanyard or rope to the conventional handle, screwed onto threads (50), and lastly, the user would insert the present invention into one end of the bore. Via a conventional controller, the user would activate mechanical actuator motor (20). When mechanical actuator motor (20) is activated, brush mount (95) will extend out from the present invention because shaft (100) will be pushed out of tube (10) by mechanical actuator motor (20). Once shaft (100) has been fully extended from tube (10), mechanical actuator motor (20) will then pull itself back on shaft (100), so that tube (10) moves forward as shaft (100) retracts into mechanical actuator motor (20).

As aforementioned, when the present invention has shaft (100) extended, the present invention would appear as shown in FIG. 3. Also, as aforementioned, when the present invention has shaft (100) completely retracted into mechanical actuator motor (20) and tube (10), the present invention would appear as shown in FIG. 2. The extension of shaft (100) and the retraction of shaft (100) continues, so that the present invention essentially extends, retracts, extends, retracts itself, and in such a way, moves through the bore of a conventional tank.

When the present invention reaches the end of the bore of a conventional tank, there is a danger that the present invention could fall out of the bore. To remedy this, the present invention has end plate (35), which is 0.162 inches smaller in diameter than the bore in which the present invention is deployed. Endplate (35) serves to keep the device from becoming oriented off access when the device reaches the end of the barrel and enables the device to be pulled back into the barrel in order to reverse its path out the front of the barrel. Endplate (35) is removable and must be changed when the device is used in different bore applications. As the present invention moves through the bore that it is cleaning, it is likely that when the present invention reaches the end of the bore, front brush (120) will extend past the end of the bore.

To prevent the present invention from falling out of the bore, the 0.162 inch diameter relationship between end plate (35) and the bore which is being cleaned will ensure that the present invention can still move within the bore, even if front brush (120) has been extended outside of the bore. When there is no more load on mechanical actuator motor (20), or in other words, that there is no resistance as front brush (120) is pushed through the bore, mechanical actuator motor (20) will either shut off, or signal the user that the present invention has reached the end of the bore. The user would then pull on a conventional lanyard or rope that is attached to the conventional handle and that is attached to threads (50). A huge amount of force is not necessary, but the user must pull the present invention slightly backwards through the bore, so that the brush direction of the present invention is reversed. In other words, conventional bristles that are disposed are front brush (120) and rear brush (110) are pointing in the opposite direction of the present invention's travel. When the present invention has moved through the bore, and then the present invention needs to move back through the bore to return to its place of entrance. The bristles are on front brush (120) and rear brush (110) will be pointing toward the rear of the present invention, or toward the end of the present invention, where rear brush (110) is located.

When the user pulls on a conventional lanyard or a conventional rope attached to a conventional handle that is attached to threads (50), the user is literally shifting the present invention ever so slightly, so that the bristles on front brush (120) and rear brush (110) will reverse the direction in which they point, and the present invention will slightly shift in a backwards direction, as the conventional bristles shift direction. Once the conventional bristles located on front brush (120) and rear brush (110) have shifted direction, these, via a conventional controller, activate mechanical actuator motor (20) to move the present invention in a reverse direction. Moving in a reverse direction means that the present invention would be moving with rear brush (110) first, and then trailing with front brush (120), as the present invention returns to its point of entrance in the bore.

It is important to recognize that the present invention operates because mechanical actuator motor (20) is powered by a 24-volt DC current that is readily available from a conventional tank or a conventional support vehicle's NATO connector. Further, it is important to recognize that the direction of the bristles on front brush (120) and rear brush (110) actually control whether the present invention moves forward or backward. For example, when the user first inserts the present invention into the bore to be cleaned, the user is bending the conventional bristles on front brush (120) and rear brush (110) backwards toward the rear of the present invention, or toward rear brush (110). When mechanical actuator motor (20) extends shaft (100) from tube (10), front brush (120) moves forward because the present invention cannot move backward because the direction of the conventional bristles on front brush (120) and rear brush (110) prevent it from doing so because of their frictional engagement with the inside of the bore being cleaned.

When the present invention reaches the end of the bore being cleaned, and the user has to slightly pull the present invention backwards via a conventional lanyard or rope attached to a conventional handle that has been screwed onto threads (50), as aforementioned, the change in bristle direction on front brush (120) and rear brush (110) that is caused by the user pulling in such a way allows the present invention, when it begins to operate once again, to travel in a rear direction. In short, because the user has changed the direction of the conventional bristles on front brush (120) and rear brush (110), when mechanical actuator motor (20) extends shaft (100) from tube (10), front brush (120), because of the direction of the conventional bristles on front brush (120), cannot move outside of the bore being cleaned, or in other words, cannot move in the direction in which the present invention has traveled through the bore, because the bristle direction has been changed.

Thus, when shaft (100) is pushed out of tube (10) by mechanical actuator motor (20), it is tube (10) and rear brush (110) that actually move away from front brush (120), and similarly, when shaft (100) is retracted into tube (10) by mechanical actuator motor (20), it is front brush (120) that is pulled along the inside of the bore being cleaned.

Tube (10) is preferably made of aluminum, or another light material that will not be unduly heavy, to prevent mechanical actuator motor (20) from moving the present invention through a bore. Further, tube (10) must be durable enough, so that typical knocks and hits will not destroy mechanical actuator motor (20). It should also be noted that the present invention is extremely efficient in terms of its use of power. In a conventional bore-cleaning system, multiple brushes would need to be pushed and pulled through the bore. In the present invention, front brush (120) and rear brush (110) are moved through the bore to clean the bore, but they are moved at separate times; or, in other words, when front brush (120) moves, rear brush (110) does not, and when rear brush (110) moves, front brush (120) does not. The present invention does not require different brushes to be used. One universal brush is used throughout the cleaning process.

Thus, the present invention is able to use mechanical actuator motor (20), powered by 24-volt DC current, to function with minimal power and the best efficiently. Mechanical actuator motor (20) is preferably a servo-motor that has a 24-volt DC input, 10.6 pounds of force per inch, 320 pounds of force minimum, 2600 RPM, 3-inch stroke, and an actuator speed that extends and retracts in 1.5 seconds. It is preferred that the actuator speed extend and retract in 1.5 seconds to allow a complete cleaning of a conventional bore in roughly 20 to 30 minutes. Further, the 2600 RPM is necessary so that the extension and retraction can occur within 1.5 seconds. The conventional servo-drive controller that is used to control movement of the mechanical actuator motor (20) is preferably a 24-volt DC input, 24-volt DC output, 18 ARMS minimum, because since 24 volts is used instead of 110 volts, the AMPS must be increased to get sufficient energy through the system, and preferably, the servo-drive controller is programmable for a home position or a retracted position and an extended position. The wire for the conventional servo-drive controller would communicates with mechanical actuator motor (20) via cord guide (80).

Alternatively, the present invention could be made with a mechanical actuator motor (20) that is powered by 110-volt current.

1-11. (canceled)

12. A bore cleaner mechanism comprising:
a housing;
an electric powered actuator positioned at least partially within the housing;
a shaft having a first end operatively connected to the electric powered actuator and a second end;
a first mount, operatively connected to the second end of the shaft, having a first cleaning device mounted thereon for use in cleaning an associated bore;
a second mount, operatively connected to the housing, having a second cleaning device mounted thereon for use in cleaning an associated bore;
a controller;
wiring for connecting the controller to the electric powered actuator and for connecting the controller to a direct current power source; and,
wherein when the bore cleaner mechanism is positioned within an associated bore: (A) the electric powered actuator can be operated to cause the first mount to move away from the housing and the second mount to thereby clean the bore with the first cleaning device; (B) the electric powered actuator can be operated to cause the housing and the second mount to move toward the first mount to thereby clean the bore with the second cleaning device; and, (C) the relative motion of the first mount with respect to the housing and the second mount causes the bore cleaner mechanism to move a desired distance through the bore.

13. The bore cleaner mechanism of claim 12 wherein:
the first cleaning device comprises a first brush; and,
the second cleaning device comprises a second brush.

14. The bore cleaner mechanism of claim 12 further comprising:
a handle for use in positioning the bore cleaner mechanism.

15. The bore cleaner mechanism of claim 14 wherein the handle comprises at least two separate sections.

16. The bore cleaner mechanism of claim 12 wherein the wiring is made to connect the controller to a 24 volt direct current power source.

17. The bore cleaner mechanism of claim 12 wherein the wiring is made to connect the controller to a vehicle's NATO connector.

18. The bore cleaner mechanism of claim 12 further comprising:
a lanyard or rope operatively connected to the bore cleaner mechanism for use in causing the bore cleaner mechanism to move within the bore in a desired direction.

19. A method comprising the steps of:
(A) providing a bore cleaner mechanism comprising: a housing; an electric powered actuator positioned at least partially within the housing; a first cleaning device mounted to a first mount; and, a second cleaning device mounted to a second mount;
(B) connecting the electric powered actuator to an electric power source;
(C) positioning the bore cleaner mechanism within an associated bore to be cleaned;
(D) activating the electric powered actuator to move the first mount away from the housing and the second mount to thereby clean the bore with the first cleaning device.
(E) activating the electric powered actuator to move the housing and the second mount toward the first mount to thereby clean the bore with the second cleaning device; and,
(F) repeating steps (D) and (E) until the bore cleaner mechanism moves longitudinally in a first direction a desired distance through the bore.

20. The method of claim 19 wherein step (A) comprises the steps of:
providing the first cleaning device as a first brush; and,
providing the second cleaning device as a second brush.

21. The method of claim 19 wherein step (B) comprises the step of:
connecting the electric powered actuator to a 24 volt direct current source.

22. The method of claim 19 wherein step (B) comprises the step of:
connecting the electric powered actuator to an associated vehicle's NATO connector.

23. The method of claim 19 wherein:
step (D) comprises the step of: extending a shaft, having a first end operatively connected to the actuator and a second end operatively connected to the first mount, out from the actuator; and,
step (E) comprises the step of: retracting the shaft into the actuator.

24. The method of claim 19 wherein:
step (A) comprises the step of: providing the first cleaning device as a first brush having bristles;
step (C) comprises the step of: positioning the bore cleaner mechanism within the bore with the first brush bristles pointed in a second direction that is substantially opposite the first direction.
step (F) comprises the step of: moving the bore cleaner mechanism through the bore in the first direction based on the second direction that the first brush bristles are pointed.

25. The method of claim 19 further comprising the steps of:
repeating steps (D) and (E) until the first mount extends outside of the bore; and,
determining that the first mount extends outside of the bore by determining that there is substantially no resistance to the movement of the first mount.

26. The method of claim 25 further comprising the step of:
providing a signal indicating that first mount extends outside of the bore.

27. The method of claim 25 further comprising the step of:
stopping the operation of the actuator.

28. The method of claim 19 further comprising the steps of:
applying a force to the bore cleaner mechanism; and,
repeating steps (D) and (E) until the bore cleaner mechanism moves longitudinally in a second direction a desired distance through the bore.

29. The method of claim 28 wherein the step of, applying a force to the bore cleaner mechanism, comprises the step of:
applying the force in a direction substantially similar to the second direction.

30. The method of claim 28 wherein:
step (A) comprises the step of: providing the first cleaning device as a first brush having bristles;
step (C) comprises the step of: positioning the bore cleaner mechanism within the bore with the first brush bristles pointed in the second direction;
the step of, applying a force to the bore cleaner mechanism, comprises the step of: positioning the first brush bristles to point in the first direction; and,
the step of, repeating steps (D) and (E) until the bore cleaner mechanism moves longitudinally in a second direction a desired distance through the bore, comprises the step of: moving the bore cleaner mechanism through the bore in the second direction based on the first direction that the first brush bristles are pointed.

31. The method of claim 19 wherein:
during step (D) the second mount does not substantially move longitudinally within the bore; and,
during step (E) the first mount does not substantially move longitudinally within the bore.
